(19) United States
(12) Patent Application Publication
(10) Pub. No.: US 2005/0061081 A1
(43) Pub. Date: Mar. 24, 2005

(54) Dual wire differential strain based sensor

(76) Inventors: Andrew G. Butler, Palo Alto, CA (US); Daniel T. Adams, Menlo Park, CA (US); Kyle Petrich, San Francisco, CA (US); Brian Lamb, Menlo Park, CA (US); Jean-Pierre Krauer, San Jose, CA (US); Zinovy Dolgonosov, San Francisco, CA (US); David Shafer, Menlo Park, CA (US); Timmy On Yung Wong, North Point (HK); Calvin Wah Pong Chan, New Territories (HK)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/668,699

(22) Filed: Sep. 22, 2003

(51) Int. Cl. G01L 1/00

(52) U.S. Cl. 73/778

(57) ABSTRACT

A force measuring apparatus uses a flexible cantilever beam engaging a tool at one end and a handle at the other end so that a force, normal to the beam, can be applied and delivered to the tool. Mounted in spaced apart longitudinal alignment on each side of the beam, is a tensioned wire, and a vibratory modulator in electromagnetic communication with the wire causing the wire to vibrate. A vibratory sensor is also positioned on each side of the beam in sensory communication with each respective wire. An electrical circuit is functionally enabled for receiving electrical signals from the vibratory sensor, the signals corresponding to a vibratory frequency of each of the wires, and for controlling the vibratory modulators to maintain the wires at resonant vibratory frequency, and for measuring a differential vibratory frequency between the wires, and finally, for calculating the magnitude of a force applied to the beam in such direction that one of the wires is incrementally further tensioned and the other of the wires is incrementally relaxed. The force magnitude is displayed on the apparatus.

### INCORPORATION BY REFERENCE

Applicant(s) hereby incorporate herein by reference, any and all U.S. patents, U.S. patent applications, and other documents and printed matter cited or referred to in this application.

### BACKGROUND OF THE INVENTION

1. Field of the Invention

This invention relates generally to vibrating sensors and more particularly to a dual wire differential vibration strain, force or torque sensor.

2. Description of Related Art

The following art defines the present state of this field: Albert, U.S. Pat. No. 6,450,032 A two-piece vibrating beam force sensor is created by utilizing one thickness of quartz for the outer mounting structure. This outer mounting structure in the case of a pressure sensor includes the mounting structure, the flexure beams and the lever arm and, in the case of an acceleration sensor, includes the mounting structure, the parallel flexure beams and the proof mass. An inner quartz structure made of a double-ended tuning fork vibrating beam assembly which provides an electrical output indicative of tension or compression applied to the beam assembly. The vibrating beam assembly is mounted on the outer quartz structure with epoxy resin or low melting temperature glass frit and suitable electrodes for stimulating the vibrating beams into vibration are provided. The resultant structure is an inexpensive, easily produced, yet highly accurate vibrating beam force sensor.

Weisbord, U.S. Pat. No. 3,470,400 teaches a single beam force transducer with integral mounting isolation.

Eer Nisse, U.S. Pat. No. 4,215,570 teaches a piezoelectric quartz force transducer having the shape of a double-ended tuning fork.

Banik, et al, U.S. Pat. No. 4,479,391 A resonator force transducer assembly includes an elongate base element, a first arm disposed generally in parallel with a front portion of the base element, a first hinge joining the arm near a rear end thereof to the base element at about the middle thereof, an elongate resonator element such as a quartz crystal attached to the front ends of the arm and base element to extend therebetween, a second arm disposed generally in parallel with a rear portion of the base element, and a second hinge joining the second arm to the base element. A third hinge joins the front end of the second arm to the rear end of the first arm to form a type of compound lever arrangement so that when a force is applied to the second arm to urge it either toward or away from the base element, a portion of this force is transmitted via the third hinge to the first arm to urge it either away from or toward the base element to thereby stress the quartz resonator element. The force applied to the second arm can be measured by causing the quartz resonator element to vibrate and then taking measurements of the change in frequency with the application of force. To protect the quartz resonator element and the rest of the force transducer assembly from corrosive effects of the environment and from ambient perturbations which may introduce error in the force measurement, the entire assembly is disposed in a vacuum enclosure. The force to be measured is then transmitted to the second arm via a rod which is attached to the arm and which extends through an opening in the enclosure. A seal between the second arm and the opening in the enclosure is provided by bellows, and another bellows in opposing relationship is provided to compensate for the effect of atmospheric pressure on the second arm introduced through the first mentioned bellows.

Amand, et al, U.S. Pat. No. 5,574,220 teaches a vibrating beam force-frequency transducer has a flat elongate blade designed to be interposed between two elements for applying a longitudinal force to the blade. The middle portion of the blade constitutes two lateral beams which are separated by a gap and which are interconnected by terminal portions of the blade. The beams carry electrodes for setting the beams into vibration in the plane of the major faces of the blade and for measuring the frequency of vibration. The terminal portions have extensions parallel to the beams and directed towards the middle of the blade in the longitudinal direction. The extensions are arranged for connecting them to the elements in zones that are closer together than are the terminal portions.

Albert, et al, U.S. Pat. No. 5,596,145 teaches a monolithic resonator for a vibrating beam device, either an accelerometer or a pressure transducer, includes an outer structure and an inner structure. The outer structure includes a mounting structure, a proof mass or pressure transfer structure and a plurality of flexure beams parallel for the accelerometer and perpendicular for the pressure transducer, extending between the mounting and either proof mass or pressure transfer structure. The inner structure is connected to the outer structure and contains isolator masses, isolator beams and a vibrating beam. The outer structure has a thickness greater than the intermediate thickness of the isolator masses which is in turn thicker than the inner structure thickness of the isolator beams and vibrating beam. The intermediate thickness is independently selected to achieve the ideal mass requirements of the vibration isolation mechanism.

Our prior art search with abstracts described above teaches various vibration related transducers but does not teach a differential vibrating wire transducer. The present invention fulfills these needs and provides further related advantages as described in the following summary.

### SUMMARY OF THE INVENTION

The present invention teaches certain benefits in construction and use which give rise to the objectives described below.

A strain based transducer uses a flexible cantilever beam fixed at its ends and with dual parallel vibrating wires longitudinally mounted to sense strain in the beam. Mounted in spaced apart longitudinal alignment on each side of the beam, is a tensioned wire, and a vibratory modulator in electromagnetic communication with the wire causing the wire to vibrate. A vibratory sensor is also positioned on each side of the beam in optical communication with each respective wire. An electrical circuit is functionally enabled for receiving electrical signals from the vibratory sensor, the signals corresponding to a vibratory frequency of each of the wires, and for controlling the vibratory modulators to maintain the wires at resonant vibratory frequency, and for measuring a differential vibratory frequency between the wires, and finally, for calculating the magnitude of strain from a force applied to the beam in such direction that one of the wires is incrementally further tensioned and the other of the wires is incrementally relaxed. A display may show strain directly or force or torque. The invention is typically applied as a torque wrench or similar tool and may also be used as part of any force measuring device and also as a strain gauge for beam flexure.

A primary objective of the present invention is to provide an apparatus and method of use of such apparatus that provides advantages not taught by the prior art.

Another objective is to provide such an invention capable of measuring beam flexure or strain.

A further objective is to provide such an invention capable of measuring torque.

A still further objective is to provide such an invention capable of measuring applied force.

A still further objective is to provide such an invention capable of measuring force through differential vibrational frequencies of a pair of vibrating wires.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIGS. 1 and 2 are perspective views of the preferred embodiment of the invention showing a bottom and a top surface respectively;

FIG. 3 is a schematic block diagram thereof;

FIG. 4 is a plot of vibrational frequency versus the tension force applied to a wire; and

FIG. 5 is a plot of differential vibrational frequency versus change in tension of the wire.

### DETAILED DESCRIPTION OF THE INVENTION

The above described drawing figures illustrate the invention in at least one of its preferred embodiments, which is further defined in detail in the following description.

The present invention is a self-calibrating dual wire differential vibrational frequency digital force or strain sensor. It compares signals taken from two vibrating wires under tension to determine an input force. This comparative approach results in a linear output signal proportional to the input force. Further, this approach enables self-calibration so that error can be kept under about 2 percent in a relatively simple and inexpensive system. Ultimately the invention results in a lower cost and more accurate device when compared to conventional tools. The principles of construction and operation are applicable to torque wrenches, force gauges, robotic force feedback systems, automotive control applications, and so on.

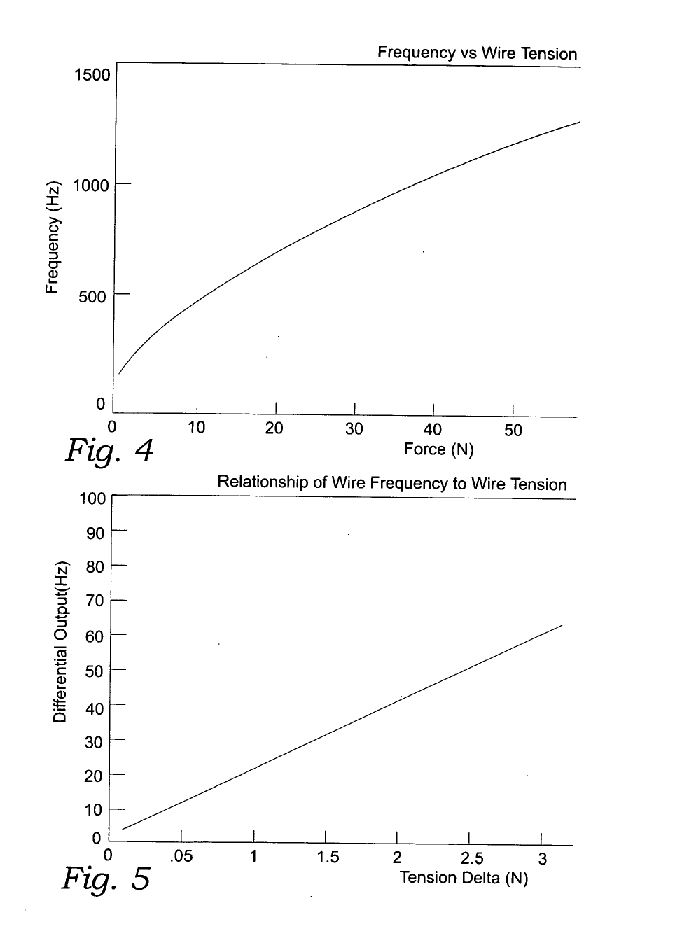

It has been shown that the frequency of vibration in a wire is a function of the square root of the applied tension force in the wire. See FIG. 4.
ω˜T^{1/2}

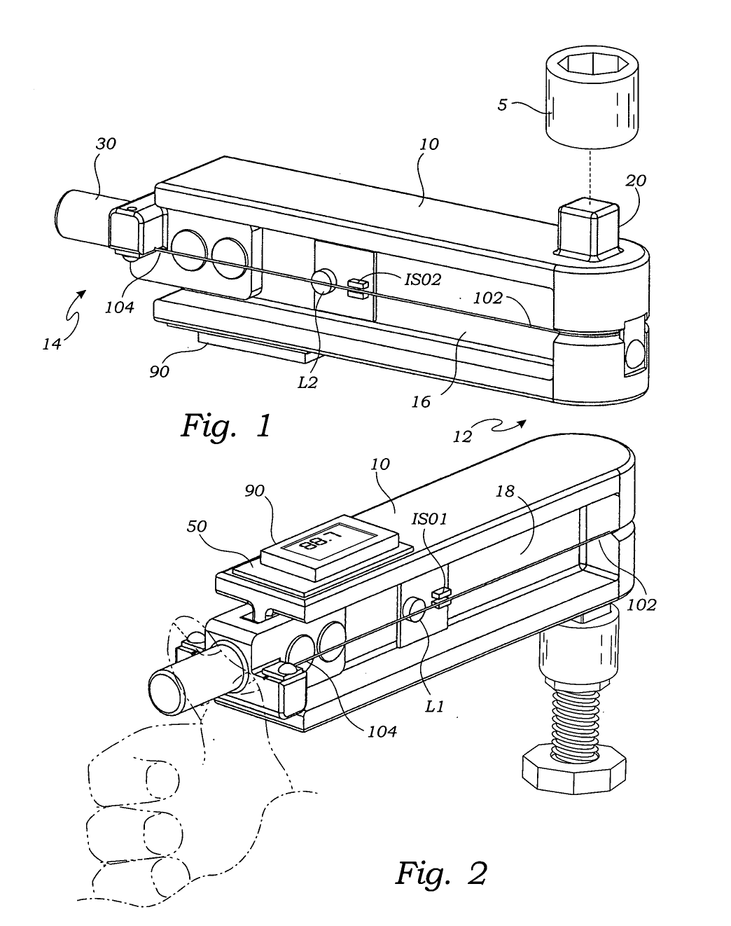

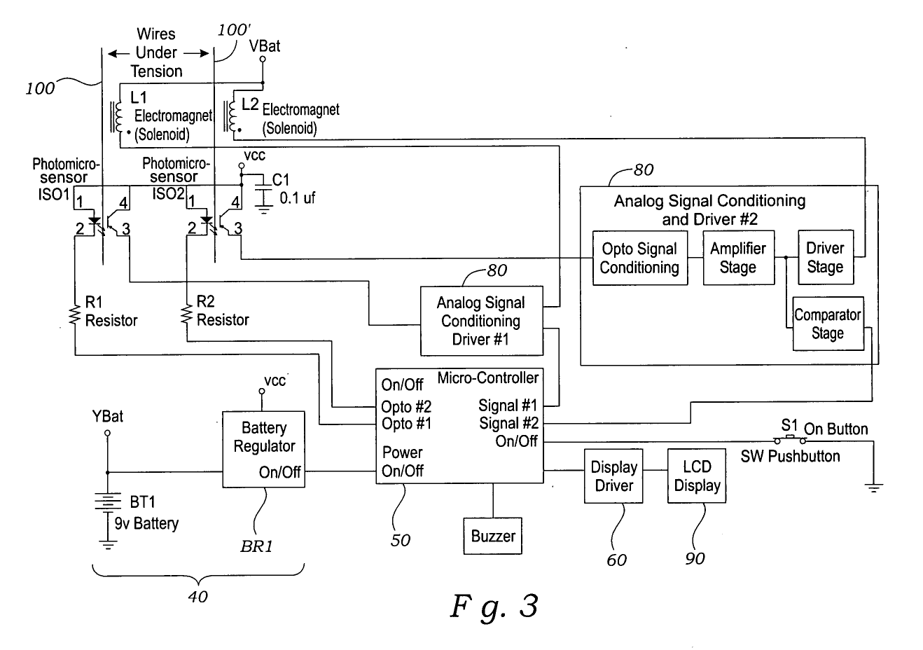

In the present invention, as shown in FIGS. 1-3, two parallel thin-gauge wires 100, 100′ having a magnetic metal component, are mounted to a beam 10. The wires are preferably made with a ferromagnetic material such as iron. Electromagnetic frequency drivers (vibratory modulators) L1 and L2 are each mounted in proximity to, but not in contact with one each of the wires 100, 100′ and are able to induce a vibration at a resonant frequency of the wire, the resonant frequency depending primarily on the stiffness of the wire, its length and its tension. Since the stiffness and length of the wires 100, 100′ are fixed, the resonant frequency of vibration of the wires 100, 100′ is dependent only on the tension force applied to the wires 100, 100′. Photo-microsensors, commonly known as optical encoders and referred to here as vibratory sensors ISO 1 and ISO 2 are each aligned with one of the wires 100, 100′ and each reads the vibrating frequency of one of the wires 100, 100′, again without touching it. A closed loop analog electronic circuit 80 is utilized to adjust to changes in wire tension and to insure vibrational resonance through feedback look control as shown in FIG. 3. For wire 100, this is accomplished by a closed loop circuit including the wire 100, the driver L1, the sensor ISO 1, and signal conditioner 80 which blocks the dc signal component, passes the desired range of ac signal, and biases the receiver portion of ISO 1. Circuit features for deriving these functions are so well known that they need not be further described here. This signal is amplified and then presented to a driver stage which varies the current in L1, i.e., the magnetic field that is used to drive the wire 100. Wire 100′ is part of an identical closed loop control system as shown in FIG. 3.

When an input force is applied to one end of the beam 10, the beam 10 is placed in strain, i.e., flexure occurs so that the wire 100, 100′ on the side of the beam 10 that strains convexly is placed under increased incremental tension, while the wire 100, 100′ on the side of the beam 10 that strains concavely is placed under reduced incremental tension. Therefore, tension in the wires 100, 100′ changes differentially increasing in one wire while decreasing in the other due to the strain in the beam 10. The resonant frequency of each wire 100, 100′ is read into an analog comparator stage to improve the precision of measurement and then to a micro-controller 50 to provide a differential signal. The differential signal is linear with respect to change in input force. See FIG. 5.

The Rao reference provides the equation for the free vibration of a uniform string with both ends fixed; the present case. Equation 8.9 is the wave equation while equation 8.27 on page 379 is the characteristic equation for a string with fixed ends, wherein values of frequency (ω) that satisfy this equation, called eigenvalues or natural frequencies, may be calculated. Equation 8.28 provides values of ωₙ directly.

The differential signal at the micro-controller 50 is digitized, scaled and presented to a display driver 60 and then on to a display 90 for visual readout of the value of force (torque). This may be expressed in units of force (pounds, ounces, kilograms, etc.) or in units of torque (foot-pounds, meter-kilograms, etc.) or in units of strain, as desired.

Continuous self-calibration of the apparatus is achieved through auto-cancellation in the differential signal. Both of the wires are subject to the same error contributors including materials degradation and physical changes such as thermal expansion and contraction due to variations in ambient temperature.

As shown, the apparatus comprises a structural cantilever beam 10 having at one end 12 thereof a tool receiver 20, such as a socket bar insert, and at an opposing end 14 thereof, a handle 30. Integral to the cantilever beam 10 is the electrical circuit including a power source 40 comprising battery BT1 and battery regulator BR1, the microcontroller 50, the means for vibratory frequency sensing ISO1 and ISO 2 which may be part number EE-SX1 107 from Omron, Inc., the means for frequency driving L1 and L2, which may be E-66-38 manufactured by Magnetic Sensor Systems, Inc., the signal conditioner-driver 80, which preferably comprises four blocks including the optocoupler a display device 90 such as the well known liquid crystal display, and the pair of longitudinally oriented, spaced apart, tensioned wires 100, 100′. Each wire 100, 100′ is attached at its ends 102, 104 to one of the two opposing sides 16, 18 of the cantilever beam 10 using common fasteners.

In FIG. 3, at the upper left, is shown two wires under tension 100, 100′. In the preferred embodiment L1 and L2 are electromagnetic solenoids that function as the means for frequency driving 70 as stated above through the effect of an alternating magnetic field on the magnetic wires. ISO 1 and ISO 2 function as the means for frequency sensing 60 stated above. ISO 1 & 2 perform the function of sensing a vibratory frequency because as wires 100, and 100′ vibrate the wires only partially block the light signal from the light emitting diode to the receiver of ISO 1 and 2, and thus, the current developed through the ISO receivers, is proportional to the rate of vibration.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

1. A force measuring apparatus comprising: a flexible beam having at one end thereof a means for rigid engagement of the beam, and at an opposing end thereof a means for applying a force normal to the beam; mounted in spaced apart longitudinal alignment on each side of the beam, a tensioned wire; a vibratory modulator in electromagnetic communication with the wire, the wire caused to vibrate thereby; and a vibratory sensor in sensory communication with the wire; an electrical circuit functionally enabled for: (i) receiving electrical signals from the vibratory sensor corresponding to a vibratory frequency of each of the wires; (ii) controlling the vibratory modulators to maintain the wires at resonant vibratory frequency; (iii) measuring a differential vibratory frequency between the wires; and (iv) calculating the magnitude of a force applied to the beam in such direction that one of the wires is incrementally further tensioned and the other of the wires is incrementally relaxed.

2. The apparatus of claim 1 wherein the wires contain a magnetic metal component.

3. The apparatus of claim 1 wherein the vibratory modulator is an electromagnetic solenoid.

4. The apparatus of claim 1 wherein the vibratory sensor is a light emitting diode combined with a light modulated junction device, an output signal from the junction device corresponding to the vibratory frequency of the wire.

5. The apparatus of claim 1 wherein, for each of the wires, a driver stage provides feedback of the electrical signals from the vibratory sensor to the vibratory modulator thereby maintaining the vibratory modulator at resonant frequency.

6. A force measuring apparatus comprising: a flexible beam having at one end thereof a means for rigid engagement of the beam, and at an opposing end thereof a means for applying a force normal to the beam; mounted in spaced apart longitudinal alignment on each side of the beam, a tensioned wire; a vibratory modulator in electromagnetic communication with the wire, the wire caused to vibrate thereby; and a vibratory sensor in sensory communication with the wire; an electrical circuit functionally receiving electrical signals from the vibratory sensors and calculating the magnitude of a force applied to the beam in such direction that one of the wires is incrementally further tensioned and the other of the wires is incrementally relaxed.

7. The apparatus of claim 6 wherein the wires contain a magnetic metal component.

8. The apparatus of claim 6 wherein the vibratory modulator is an electromagnetic solenoid.

9. The apparatus of claim 6 wherein the vibratory sensor is a light emitting diode combined with a light modulated junction device, an output signal from the junction device corresponding to the vibratory frequency of the wire.

10. The apparatus of claim 6 wherein, for each of the wires, a driver stage provides feedback of the electrical signals from the vibratory sensor to the vibratory modulator thereby maintaining the vibratory modulator at resonant frequency.

11. A force measuring method comprising the steps of: applying a force to one end of a flexible beam while holding another end of the beam rigidly; mounting in spaced apart longitudinal alignment on each side of the beam, a tensioned wire in such direction that one of the wires is incrementally further tensioned and the other of the wires is incrementally relaxed when the beam is under strain from the applied force; mounting on each side of the beam, a vibratory modulator in electromagnetic communication with the wire thereby causing the wire to vibrate, and a vibratory sensor in sensory communication with the wire; receiving an electrical signal from the vibratory sensors corresponding to a vibratory frequency of each of the wires; controlling the vibratory modulators to maintain the wires at resonant vibratory frequency; measuring a differential vibratory frequency between the wires; and calculating the magnitude of the force applied to the beam from the differential vibratory frequency.

12. A strain measuring method comprising the steps of: applying a force to one end of a flexible beam while holding another end of the beam rigidly to cause the beam to strain; mounting in spaced apart longitudinal alignment on each side of the beam, a tensioned wire in such direction that one of the wires is incrementally further tensioned and the other of the wires is incrementally relaxed when the beam is under strain from the applied force; mounting on each side of the beam, a vibratory modulator in electromagnetic communication with the wire thereby causing the wire to vibrate, and a vibratory sensor in sensory communication with the wire; receiving an electrical signal from the vibratory sensors corresponding to a vibratory frequency of each of the wires; controlling the vibratory modulators to maintain the wires at resonant vibratory frequency; measuring a differential vibratory frequency between the wires; and calculating the magnitude of the strain in the beam from the differential vibratory frequency.
